(19) United States
(12) Patent Application Publication
(10) Pub. No.: US 2017/0043671 A1
(43) Pub. Date: Feb. 16, 2017

(54) CONTROL SYSTEM FOR ELECTRIC VEHICLE SERVICE NETWORK

(71) Applicant: Charge Peak Ltd., Toronto (CA)

(72) Inventor: Daniel Campbell, Tel-Aviv (IL)

(21) Appl. No.: 15/118,746

(22) PCT Filed: Feb. 13, 2014
(86) PCT No.: PCT/IL14/50155

§ 371 Date: Aug. 12, 2016

(51) Int. Cl. B60L 11/18; G08G 1/01; G01C 21/34

(52) U.S. Cl. CPC B60L 11/1824; G01C 21/34; B60L 11/1822; G08G 1/0112; G08G 1/0129

(57) ABSTRACT

The present disclosure provides a control system for monitoring an electric vehicle service network which comprises a plurality of service stations providing electric energy reload to a fleet of electric vehicles. The control system is configured and operable for communication with the electric vehicles via a communication network, and comprises: a processing unit configured for aggregating vehicle route planning information associated with at least some of the electric vehicles to build forecast data of the flow of electric vehicles to the service stations over time; and a service time estimation unit configured and operable for utilizing the forecast data and evaluating the service duration for servicing a given electric vehicle at a given service station and at a given service time based on said forecast.

### TECHNOLOGICAL FIELD

The present disclosure relates generally to electric vehicles. More specifically, the disclosed embodiments relate to systems and methods of estimating a time required to service an electric vehicle at a service station of an electric vehicle service network.

### BACKGROUND

The vehicle (e.g., cars, trucks, planes, boats, motorcycles, autonomous vehicles, robots, forklift trucks etc.) is an integral part of the modern economy. Unfortunately, fossil fuels, like oil which is typically used to power such vehicles, have numerous drawbacks including: a dependence on limited sources of fossil fuels; the sources are often in volatile geographic locations; and such fuels produce pollutants and likely contribute to climate change. One way to address these problems is to increase the fuel efficiency of these vehicles.

Recently, gasoline-electric hybrid vehicles have been introduced, which consume substantially less fuel than their traditional internal combustion counterparts, i.e., they have better fuel efficiency. Fully-electric vehicles are also gaining popularity. Batteries play a critical role in the operation of such hybrid and fully-electric vehicles. However, present battery technology does not provide an energy density comparable to gasoline. On a typical fully charged electric vehicle battery, the electric vehicle may only be able to travel up to 40 miles before needing to be recharged. In other words, for a given vehicle storage, the electric vehicles travel range is limited. Therefore, in order for a vehicle to travel beyond the single-charge travel range, the spent battery needs to be charged or exchanged with a fully-charged battery.

International patent publication No. WO 2010/033517, assigned to the Assignee of the present application, discloses a system for managing energy usage of an electric vehicle capable of reloading at a service station of an electric vehicle service network. According to the disclosure of WO 2010/033517, the electric vehicle incorporates an energy-aware navigation module which provides route planning (energy plan) to a driver based notably on the charge status of a battery of the electric vehicle, a destination of the driver and the proximity to service stations of the electric vehicle service network. The electric vehicle further communicates with a control center providing to the electric vehicle status information of the service stations in proximity.

### GENERAL DESCRIPTION

The present disclosure proposes notably to improve information provided by the control center to the electric vehicle. Indeed, centralizing route guidance information (route planning) for at least some of the electric vehicles enables to anticipate the flow of electric vehicles to the service stations. This particularly allows establishing precise service time estimation for a given vehicle at a given service station and at a given service time i.e. permits to estimate precisely the amount of time that a user will spend at a service station. In fact, retrieving the route planning information (recommendations) of each (or at least some) electric vehicle in the control center or directly implementing the route guidance determination centrally within the control center leads to an approximate knowledge of when the electric vehicle reach the service station and thereby to obtain an estimation of the flow of electric vehicles to the service stations over time. The precision of the estimation may additionally rely on traffic forecasts and other parameters as described in more details below.

Electric vehicles (also referred to as EV) in the following are using rechargeable batteries which require servicing to provide continues power output. There are two types of services that are performed on batteries. The first one is “charging” which is performed by connecting the battery to a charging spot (also referred to as charge spot) thereby allowing the vehicle to be charged from the power grid. The second one is “switching” (also referred to as swap(ing)) which is performed by replacing a discharged battery by a charged battery at battery swapping stations (also referred to as swap station). There is a need to provide the user of the EV with an indication as for the duration of the servicing procedure.

In a standard implementation, the charging duration may be estimated based on the technical specification of the battery in the EV i.e. a current charging state of the battery, a maximal charging current supported by the battery and a maximum capacity of the battery. However, this may not reflect the actual charge time as limitations on charging current may be imposed due to charging infrastructure or grid capabilities. As for the swap procedure, the typical or average time may be known or reported to user, but this again may not reflect correctly the required time, as congestion due to multiple users may prolong the process significantly. The present invention attempts to provide an accurate estimation of service duration.

The present disclosure utilizes a managed (supervised) charging infrastructure. The infrastructure includes managed charging spots, managed battery swapping stations, in-vehicle system and a control center (also referred to as control center system). All of these elements may be connected to the control center via wireless or wired communication networks. The control center may also be connected to power utility companies grid management that provides information on currently available power capacity in different locations of the grid.

The control center alone or in combination with a charging spot controller (i.e. a computer system of the charge spot controlling the charge spot operation) may determine the available current capacity of the charge spot and the typical currents that it may supply to EVs that may start charging on said charge spot at a specific time. This calculation may be based on the current and expected load on the charge spot (i.e. number of EVs hooked/connected to the charge spot), the physical limitation of current supply to this charge spot (type of power lines connected to it, maximal current allowed on said power lines, etc.) as well as current grid output capacity and optionally also payments rate for power at said specific time and at the location of the charge spot.

For the swap procedure, the control center alone or in combination with a swapping station controller (i.e. a computer system of the swap station controlling the swap station operation) can determine the expected waiting time and swap time at that swap station for an EV arriving to the swap station at a given time. The calculation may be based on the current inventory state of batteries and their charging state in the swap station, the number of expected EVs over time that may reach that specific swap station based on control center statistical data as well as current servicing plans to the EVs serviced by the control center (based on the EV flow forecast at the swap station), and the capacity and typical swap times as provided by the swap station based on preconfigured numbers and/or statistical historical data.

In combination with information provided from the in-vehicle system that provides information on current location state of battery and optionally travel destination, the control center, the in-vehicle system or a combination of both, can determine a service plan (energy plan) for the battery that includes servicing stops at specific locations and specific times for charging or swapping. For every planned servicing point, the control center can then—based on the calculation as explained above-determine the amount of time that the EV is expected to spend in the charging spot or swap station. The information may be reported to the in-vehicle system and reported to the EV user via an in-vehicle display system. In some embodiment multiple alternative servicing points are presented to the user with the servicing time estimation for each of them. In additional embodiment the information includes the expected average time as well as expected time tolerance (i.e. 50 minutes+−10 minutes)

In a first broad aspect, the present disclosure provides a control system for monitoring an electric vehicle service network. The electric vehicle service network comprises a plurality of service stations providing electric energy reload to a fleet of electric vehicles. The control system is configured and operable for communication with the electric vehicles via a communication network. The control system comprises a processing unit configured for aggregating vehicle route planning information associated with at least some of the electric vehicles to build forecast data of the flow of electric vehicles to the service stations over time, wherein the route planning information of a vehicle comprises data indicative of one or more stops at one or more service stations over time if a final destination of said electric vehicle is out of range of said vehicle; a service time estimation unit configured and operable for utilizing the forecast data and evaluating the service duration for servicing a given electric vehicle at a given service station and at a given service time based on said forecast. For example, the route planning information may associate the one or more service stations with expected times of arrival. The time of arrival may be evaluated based on the distance between the vehicle and the respective stations and optionally on traffic conditions or on other conditions.

In some embodiments, the control system further comprises an electric vehicle supervision unit configured for receiving from at least some of the electric vehicles data relative to a battery charge status, a vehicle location and a vehicle final destination of said electric vehicles. The processing unit is configured to process said data to obtain the vehicle route planning information of said electric vehicles. For example, certain vehicles may transmit to the control center ‘raw’ data and the control center may be in charge of processing these data in order to obtain the route planning information relative to a vehicle. This enables to improve the supervision of the fleet of electric vehicles. The route planning information of a vehicle may be transmitted to said vehicle for informing the driver. The route planning information may comprise several route recommendations and the control center may propose to the driver to choose among the route recommendations. The route planning information may be processed periodically or upon request or upon update of the route planning of one of the electric vehicle of the fleet.

In some embodiments, the electric vehicle supervision unit is configured for receiving from at least some of the electric vehicles data relative to the vehicle route planning of said electric vehicles. For example, certain vehicles may process the route planning information and transmit the processed data to the control center. This enables to lower the load on the control center.

In some embodiments, the service time estimation unit is configured for evaluating a load status at the given service station and at the given service time so as to determine a waiting time prior to servicing the electric vehicle.

In some embodiments, the given service station is a given charge spot and the service time estimation unit is configured for estimating a current available for charging the battery of said electric vehicle at said charge spot and at said service time so as to evaluate a charging time for charging the battery.

In some embodiments, the control system further comprises a power network supervision unit configured for determining a dynamic current supply limitation at one or more charge spots of the electric vehicle service network and wherein the service time estimation unit is configured for refining the available current estimation based on the dynamic current supply limitation.

In some embodiments, the control system further comprises a infrastructure supervision unit configured for storing infrastructural current supply limitation at one or more charge spots of the electric vehicle service network and wherein the service time estimation unit is configured for refining the available current estimation based on the infrastructural current supply limitation at the given charge spot.

In some embodiments, the control system further comprises a charge spot supervision unit configured for requesting and receiving data relative to a number of electric vehicle charging on a charge spot at a time of request and wherein the service time estimation unit is configured for refining the expected number of electric vehicle serviced by the given charge spot at a given time based on said received data.

In some embodiments, the given service station is a swap station and the service time estimation unit is configured for evaluating the service duration based on a waiting time prior to the battery swap at the given service time estimated by determining a number of vehicles awaiting for a battery swap at the swap station and at the given service time.

In some embodiments, the control system further comprises a swap station supervision unit configured for requesting and receiving to and from the swap stations data relative to a number of electric vehicle awaiting at said swap stations at a time of request and wherein the service time estimation unit is configured for refining the waiting time at the given service time at the given swap station based on the number of vehicle awaiting at said swap station at the time of request.

In some embodiments, the swap station supervision unit is further configured for requesting and receiving to and from the swap stations an inventory of the batteries available at said swap stations at a time of request and the service time estimation unit is configured for determining the waiting time at a given swap station at a given service time for a given electric vehicle based on said inventory.

In some embodiments, the inventory of the batteries available at a swap station at a time of request comprises data relative to a type of battery and a charge status.

In some embodiments, the electric vehicles of the fleet are associated with a level of servicing priority and the service time estimation unit is configured for refining the service duration for servicing a given vehicle based on the level of servicing priority of said vehicle.

In some embodiments, the control center is configured to periodically receive use data from the plurality of service stations so as to build a statistical use distribution of the service stations over time and wherein the service time estimation unit is configured for refining the service duration based on said statistical use distribution.

In some embodiments, the control system further comprises a service time communication unit configured for transmitting the service time estimation to the electric vehicles.

In another broad aspect, the present disclosure provides a method of estimating a service duration for servicing an electric vehicle of a electric vehicle fleet at a service station of an electric vehicle service network. The method comprises establishing route planning for at least some electric vehicles of the fleet by processing data relative to a battery charge status, a vehicle location and a vehicle final destination of said electric vehicles, wherein the route planning information of an electric vehicle includes one or more service station stops over time if the final destination is out of range of the vehicle given the battery charge status and the location of said vehicle; aggregating the route planning from said at least some electric vehicle to build a forecast data of the flow of electric vehicles to the services stations over time; and utilizing the forecast data and evaluating the service duration for servicing a given electric vehicle at a given service station and at a given service time based on said forecast data.

In another aspect, the present disclosure provides a computer program product adapted to perform the method previously described.

In another aspect, the present disclosure provides a computer readable storage medium comprising the program previously described.

### BRIEF DESCRIPTION OF THE DRAWINGS

In order to understand the disclosure and to see how it may be carried out in practice, embodiments will now be described, by way of non-limiting example only, with reference to the accompanying drawings, in which:

FIG. 1 is a diagram illustrating an electric vehicle collaborating with a control system and an electric vehicle service network according to embodiments of the present disclosure.

FIG. 2 is a block diagram illustrating steps of a method for estimating a service duration according to embodiments of the present disclosure.

FIG. 3 is a diagram illustrating a control system collaborating with an electric vehicle, a charge spot and an electric power supply network according to embodiments of the present disclosure.

FIG. 4 is a block diagram illustrating steps of a method for estimating a service duration at a charge spot according to embodiments of the present disclosure.

FIG. 5 illustrates a control system collaborating with an electric vehicle and a swap station according to embodiments of the present disclosure FIG. 6 is a block diagram illustrating steps of a method for estimating a service duration at a swap station according to embodiments of the present disclosure.

Like reference numerals refer to corresponding parts throughout the drawings.

### DETAILED DESCRIPTION OF EMBODIMENTS

Described herein are some examples of systems and methods for estimating a service duration for servicing a vehicle at a given time and at a given service station of a electric vehicle service network.

In the following detailed description, numerous specific details are set forth in order to provide a thorough understanding of the subject matter. However, it will be understood by those skilled in the art that some examples of the subject matter may be practiced without these specific details. In other instances, well-known methods, procedures and components have not been described in detail so as not to obscure the description.

As used herein, the phrase “for example,” “such as”, “for instance” and variants thereof describe non-limiting examples of the subject matter.

Reference in the specification to “one example”, “some examples”, “another example”, “other examples, “one instance”, “some instances”, “another instance”, “other instances”, “one case”, “some cases”, “another case”, “other cases” or variants thereof means that a particular described feature, structure or characteristic is included in at least one example of the subject matter, but the appearance of the same term does not necessarily refer to the same example.

It should be appreciated that certain features, structures and/or characteristics disclosed herein, which are, for clarity, described in the context of separate examples, may also be provided in combination in a single example. Conversely, various features, structures and/or characteristics disclosed herein, which are, for brevity, described in the context of a single example, may also be provided separately or in any suitable sub-combination.

Unless specifically stated otherwise, as apparent from the following discussions, it is appreciated that throughout the specification discussions utilizing terms such as “generating”, “determining”, “providing”, “receiving”, “using”, “coding”, “handling”, “compressing”, “spreading”, “transmitting”, “amplifying”, “performing”, “forming”, “analyzing”, “or the like, refer to the action(s) and/or process(es) of any combination of software, hardware and/or firmware. For example, these terms may refer in some cases to the action(s) and/or process(es) of a programmable machine, that manipulates and/or transforms data represented as physical, such as electronic quantities, within the programmable machine's registers and/or memories into other data similarly represented as physical quantities within the programmable machine's memories, registers and/or other such information storage, transmission and/or display element(s).

The term “route planning” is used therein in reference to an operation of determining directions taking into account the energy need of the battery of the electric vehicle. The electric vehicle is indeed provided with an energy-aware navigation system which is configured to plan routes including one or more stops at service stations if the final destination is out of range of the battery. In the following, it is considered that the route planning of at least some (and preferably all) electric vehicles of the fleet of electric vehicles are centralized (aggregated) in the control center system.

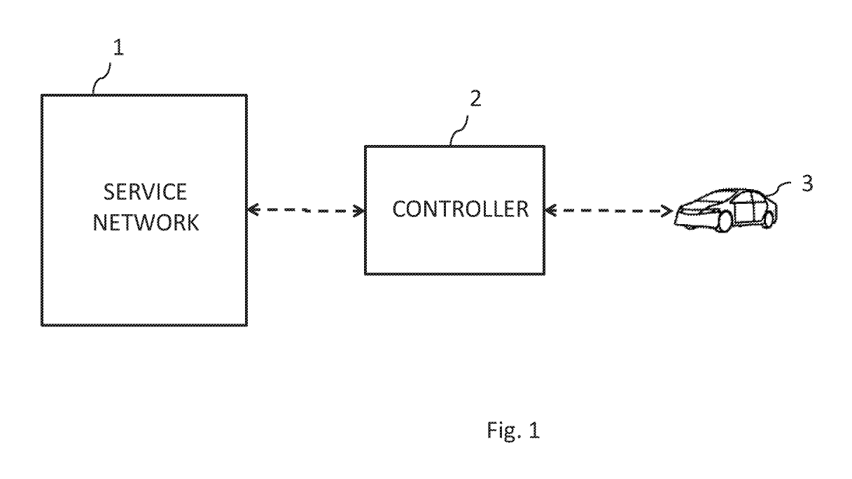

FIG. 1 generally illustrates an electric vehicle service network 1 collaborating with a control system 2 and an electric vehicle 3 of a fleet of electric vehicles.

The electric vehicle service network 1 may include battery service stations configured to provide energy to an electric vehicle 3. In particular, the electric vehicle service network 1 may comprise one or more charge stations for charging the one or more batteries and/or one or more swap stations to exchange the one or more batteries from the electric vehicle 3. The electric vehicle service network 1 may also comprise bi-stations comprising both a charging station and a swap station. The charge station may comprise one or more charging lines for enabling EV electric connection. The swap station may comprise one or more battery swap lanes for the EV to be serviced. A battery swap lane may include a conveyor system for conveying the EV to a swap platform where the battery is exchanged. Battery service stations are described in greater detail in International patent publication No. WO2010/033881, which is hereby incorporated by reference in its entirety. For example, the one or more batteries of the electric vehicle may be charged at one or more charge stations, which may be located on private property (e.g., the home of the user, etc.), on public property (e.g., parking lots, curbside parking, etc.), or at or near battery exchange stations. Furthermore, in some embodiments, the one or more batteries of the electric vehicle may be exchanged for charged batteries at the one or more battery exchange stations within the electric vehicle service network 1. Thus, if a user is traveling a distance beyond the range of a single charge of the one or more batteries of the electric vehicle 3, the spent (or partially spent) batteries may be exchanged for charged batteries so that the user can continue with his/her travels without waiting for the battery pack to be recharged. The term “battery service station” is used herein to refer to battery exchange stations (e.g., battery exchange station), which exchange spent (or partially spent) batteries of the electric vehicle for charged batteries, and/or charge stations, which provide energy to charge a battery pack of an electric vehicle. Furthermore, the term “charge spot” and/or “charging station” may also be used herein to refer to a “charge station.”

The electric vehicle 3 may be configured to communicate with the control center system 2 and the electric vehicle service network may also be configured to communicate with the control center system 2. The electric vehicle 3 may also communicate with the service network 1 directly. The control center system 2 may be configured to act as a router for enabling communication between the service network 1 and the electric vehicle 3. Although not explicitly illustrated in FIG. 1, a communications network may be coupled to the vehicle 3, the control center system 2, and the service network 1. In some embodiments, any of the vehicle 3, the control center system 2, the charge station, and/or the battery exchange station of the service network 1 may include a communication module that can be used to communicate with each other through the communications network.

The electric vehicle 3 may have one or more electric motors, one or more batteries, a positioning system and a communication module. The one or more electric motors may drive one or more wheels of the electric vehicle. The one or more electric motors may receive energy from the one or more batteries that are electrically and mechanically attached to the electric vehicle.

The positioning system may be configured to determine the geographic location of the electric vehicle 3 based on information received from a positioning network. The positioning network may include: a network of satellites in a global satellite navigation system (e.g., GPS, GLONASS, Galileo, etc.), a network of beacons in a local positioning system (e.g., using ultrasonic positioning, laser positioning, etc.), a network of radio towers, a network of Wi-Fi base stations, and any combination of the aforementioned positioning networks. Furthermore, the positioning system may include a navigation system that generates routes and/or guidance (e.g., turn-by-turn or point-by-point, etc.) between a current geographic location of the electric vehicle and a destination.

The navigation system may receive a destination selection from a user, and provide driving directions to that destination. In some embodiments, the navigation system communicates with the control center system 2, and receives service station information (as well as other data) from the control center system 2. The communication module may include hardware and software and may be used to communicate with the control center system 2 (e.g., associated with a service provider) and/or other communication devices via a communications network.

In some embodiments, the control center system 2 is configured to provide to the electric vehicle 3 route recommendations (route planning information) including a list of proposed routes which may include one or more stops at suitable service stations (e.g., within the maximum theoretical range of the electric vehicle; has the correct type of batteries; etc.). The route recommendations may include data relative to the status of said suitable service stations including: a number of electric vehicles that may be hooked at the charge spot at an expected time of arrival at said charge spot, a number of charge lines of the charge spot that may be available to hook on at the expected time of arrival, an estimated time until charge completion for the vehicles that may be hooked to the charge spot at the expected time of arrival, a number of battery exchange bays of a swap station that may be occupied at the expected time of arrival, a number of battery exchange bays of the swap station that may be free at the expected time of arrival, a number of suitable charged batteries available at the swap station at the expected time of arrival, a number of spent batteries at the swap station at the expected time of arrival, the types of batteries available at the swap station at the expected time of arrival, an estimated service duration (i.e. the time required to service the electric vehicle) at the expected time of arrival (i.e. an estimated duration needed to charge the battery at the charge spot or an estimated duration needed to swap the battery at the swap station. The estimated service duration may respectively be a sum of: an estimated time until an exchange bay of a swap station will become free or an estimated time until a charge line of a charge spot will become free and a battery charge time or a battery exchange time. In some embodiments, the route recommendations may be processed by a computer system embedded in the electric vehicles 3 and transmitted to the control center system 2 so that the control center system 2 be able to assess an electric vehicle flow to the battery service stations of the service network 1 over time.

In some embodiments, the control center system 2 also provides access to the battery service stations to the electric vehicle 3. For example, the control center system 2 may instruct a charge station to provide energy to recharge the one or more batteries after determining that an account for the user is in good standing. Similarly, the control center system 2 may instruct a battery exchange station to commence the battery exchange process after determining that the account for the user is in good standing. Further, the users may be given different service priority level so that a given user may be provided with an improved service such as: an improved charging time by allocating a higher current to the charge of the battery, a privilege for avoiding waiting in line, etc.

The control center system 2 may obtain information about the electric vehicles and/or battery service stations by sending queries through the telecommunications network to the electric vehicle 3 and to the battery service stations (e.g., charge stations, battery exchange stations, etc.) of the electric vehicle service network 1. This may enable the control center system 2 to establish the route recommendations for the electric vehicles 3. For example, the control center 2 may receive a request for establishing a route recommendation of an electric vehicle based on a final destination defined by a user of the electric vehicle 3. The control center system 2 may query the electric vehicle 3 to determine a geographic location of the electric vehicle 3 and a status of the one or more batteries of the electric vehicle 3. Alternatively, the electric vehicle 3 may send this information (final destination, location and charge status) together with a request for route recommendation. The control center system 2 can also query the electric vehicle 3 to identify a user-selected final destination of the vehicle 3. The control center system 2 may also query the electric vehicle service network 1 to determine the status of the battery service stations. The status of battery service stations includes, for example, information about the replacement batteries at an exchange station (including the number, type and charge status of those batteries), reservation information (based on information relative to the EV flow to said service station) for replacement batteries or charge spots, etc.

The control center system 2 may also send information and/or commands through the communications network to the battery service stations. For example, the control center system 2 may send an instruction to increase or decrease a charge rate of one or more replacement batteries coupled to the electric vehicle network at the battery service station. The control center system 2 may send an instruction to a battery service station to change (i.e., increase or decrease) the number of available replacement batteries at a battery service station (e.g., by acquiring batteries from a different battery service station, or a battery storage location).

In some embodiments, the battery service stations provide status information to the control center system 2 via the communications network directly (e.g., via a wired or wireless connection using the communications network). In some embodiments, the information transmitted between the battery service stations of the electric vehicle service network 1 and the control center system is transmitted in real-time. In some embodiments, the information transmitted between the battery service stations and the control center system 2 are transmitted periodically (e.g., once per minute).

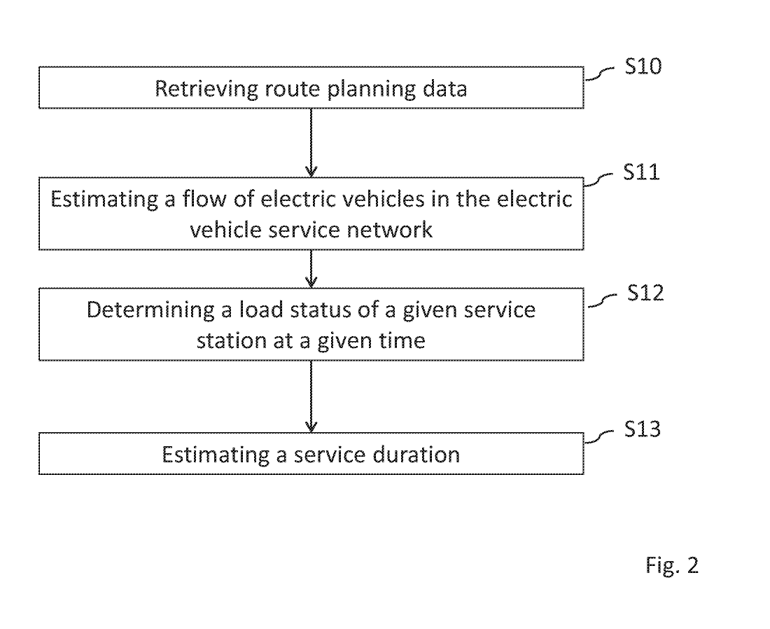

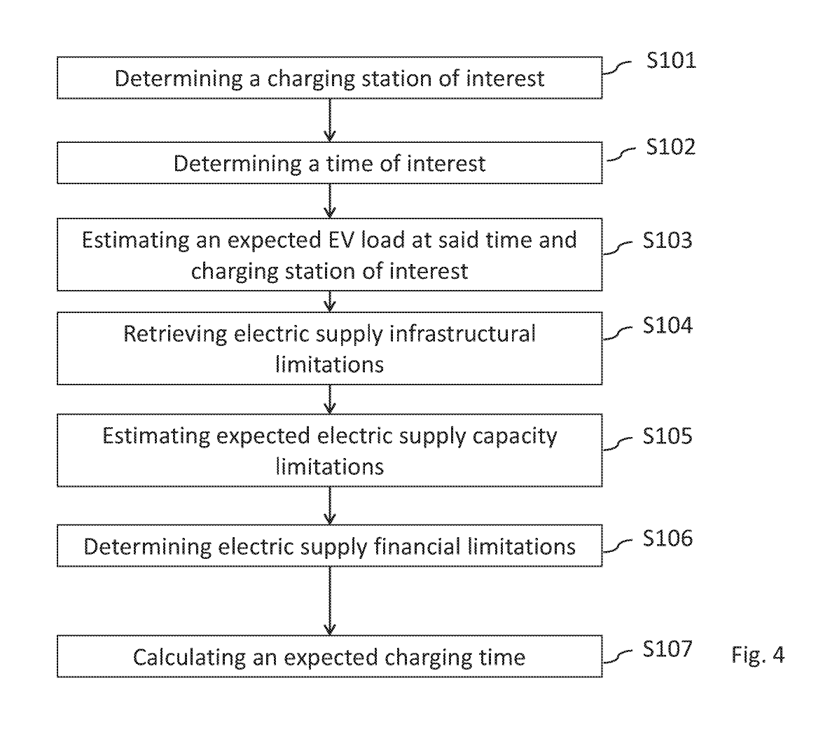

FIG. 2 illustrates steps of a method for estimating a service duration at a given service station at a given service time. In a first step S10, route planning information (recommendations) of at least some of the electric of the fleet of electric vehicles are retrieved by the control center system. In an embodiment, the route planning information may be established in a computer embedded in each electric vehicle and step S10 then comprises a step of transmission of the route planning information to the control center. In another embodiment, the route planning information may be established by the control center system, for example on request of the electric vehicles, based at least on a final destination, a charge status of the battery of the electric vehicle and a location of the electric vehicle, and then step S10 may comprise a step of retrieving the data from a memory storage of the control center system). The final destination, charge status and location of the electric vehicle may be transmitted by the electric vehicle to the control center. For example, the transmission may occur automatically when a driver inputs a final destination by using a navigation system of the electric vehicle. In a second step S11, the attendance of the electric vehicles to the service stations is estimated over time based on the route planning information of the fleet of electric vehicles. In fact, centralizing the route planning information of the fleet of electric vehicles enables the control center system to have an overview of the flow of electric vehicles to the service stations of the electric vehicle service network. The access to the service stations may be reserved automatically when an electric vehicle accepts a route recommendation (planning) and the access to the service stations may be limited for electric vehicles which have not reserved a service station. Therefore, most electric vehicle may naturally follow the route recommendation established for arriving to their final destination. This way, gathering (aggregating) the route planning information of the fleet of electric vehicles may enable to estimate an expected flow of electric vehicles to the service stations over time. The precision of the EV flow estimation may be improved by collecting information on other parameters such as traffic estimations, weather conditions and other parameters having influence on the traffic of vehicles. In a third step S12, a load status of a given service station at a given time is determined. For example, if the service station is a charge spot, the load status may include a number of charging lines available at said given time. If the service station is a swap station, the load status may include a number of battery swap lanes available at said given time. This may enable to determine a waiting time prior to servicing the EV. In a fourth step S13, a service duration for servicing a given vehicle at a given service station at a given service time is estimated based on the load status. The given service time may be a predicted time of arrival based on the location of the electric vehicle and on various parameters like road conditions, car model, weather conditions, time of the day, etc. The service duration may be estimated as a sum of a waiting time prior to servicing due to congestion and a servicing time. At a swap station, the waiting time may take into account the availability of a suitable battery. In this purpose, the control system may be configured to determine an expected number of suitable batteries i.e. at least partially charged and of a battery type suitable for the given vehicle. At a charge spot, the servicing time (charging time) may be determined by evaluating an available current for charging the EV taking into account infrastructural limitations of the charge spot, charging priority levels of the EV expected at the charge spot at the given time and/or financial constraints. More details as to the service duration evaluation in the case of a charging are given with reference to FIG. 4. More details as to the service duration estimation in the case of a swapping are given with reference to FIG. 6.

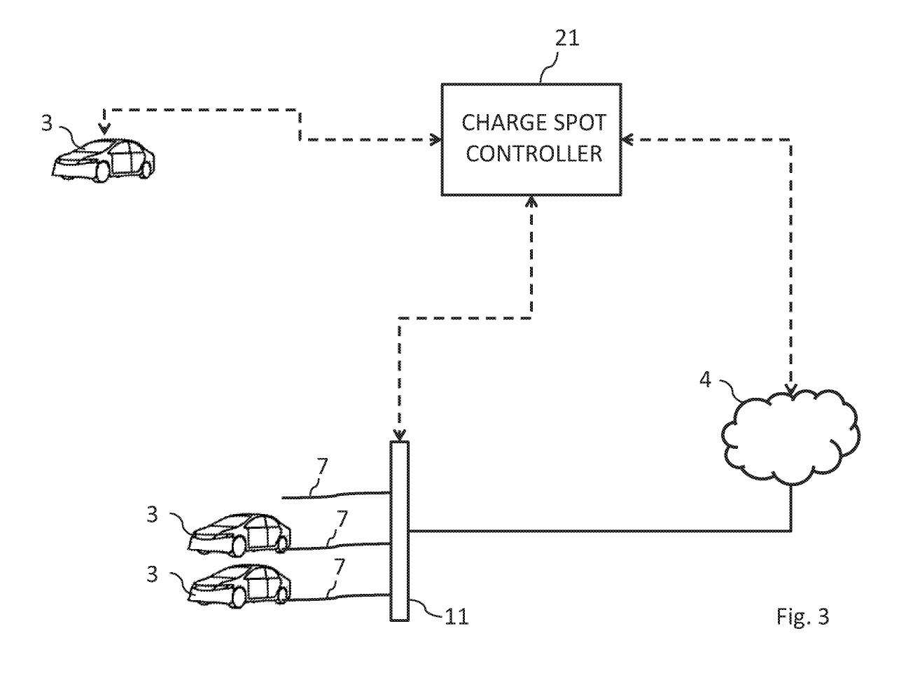

FIG. 3 shows an exemplary case in which the electric vehicle service network comprises a charge spot. The charge spot 11 is part of the electric vehicle service network presented in FIG. 1 and the charge spot controller 21 is part of the control center system presented in FIG. 1. In the sake of conciseness, the general features relative to the electric vehicle, service station and control center system which are common are not repeated hereinbelow and only details relevant to the exemplary case illustrated are hereby further added. Particularly, FIG. 3 illustrates a control system collaborating with an electric vehicle 3, a charge spot 11 and a power grid 4.

The charge spot 11 may provide electric current to the electric vehicles 3 for charging the batteries of said vehicles. The charge spot 11 may be supplied with electric power from the power grid 4. The power line (cable) connecting the power grid 4 to the charge spot 11 may have a maximal current limit (charge spot supply limit) preventing the charge spot 4 to retrieve more than a certain amount of current from the power grid 4. Therefore, a first infrastructural electric supply limitation may be given by the charge spot supply limit. The charge spot 11 may comprise charging lines 7 on which electric vehicles 3 can hook on to charge their battery. The charging lines 7 may also have a maximal current limit (charging line supply limit) preventing the charging line 7 to provide more than a certain amount of current to the electric vehicle 3 hooked to the charging line 7. Therefore, a second infrastructural electric supply limitation may be given by the charging line supply limit. The charge spot 11 may communicate with the charge spot controller 21 to update periodically or on request the status of the charging lines 7. The status may include data relative to a free or busy state of the charging lines 7 and/or information relative to the amount of current provided by the charging lines 7 of the charge spot 11. The infrastructural electric supply limitation of the charge spot 11 may be provided to the charge spot controller 21. This may enable the charge spot controller 21 to refine the estimation of the available current. For example, the infrastructural limitation of the charge spots of the electric vehicle service network may be stored in a storage memory of the charge spot controller 21.

Further, dynamic electric supply limitation may also be encountered because of limitations due to the power grid capacity. The charge spot 11 may occasionally be prevented from retrieving more than a dynamic limit current from the power grid 4. This may happen in the event that the power grid is heavily solicited for examples at peak hours or in specific geographical areas with high electrical consumption. The dynamic electric supply limitation may be provided to the charge spot controller 21. The charge spot controller 21 may store the dynamic current limitation over time and build statistical data. The charge spot controller 21 may use the dynamic electric supply limitation to refine the evaluation of the available current. The dynamic electric supply limitation may be transmitted to the charge spot controller 21 by the charge spot 11 or by the power grid management company.

Furthermore, the available current for charging a given vehicle at a given service time and at a given charge spot may be limited by voluntary limitations. For example, in the event that the price of the electric power would exceed a certain price limit, the charge spot controller may voluntarily decide to limit the current provided for financial reasons. In order to determine the financial constraints, financial data relative to the electric power supply may be provided to the charge spot controller by the power grid management company.

The charge spot controller 21 is configured to evaluate the service duration for servicing a given electric vehicle 3 at a given charge spot 11 and at a given service time based on the forecast of the EV flow to the charge spot. The charge spot controller 21 may determine at said service time (i.e. the expected time of arrival at the charging point taking optionally account of a waiting time if all the charging lines of the charge spot are busy at the time of arrival) a load status of the charge spot i.e. how many charging lines should be busy. From the load status, the charge spot controller 21 may derive a waiting time prior to charging of the vehicle. Further, an available current for charging the vehicle may be estimated taking into account the infrastructural electric supply limitations, the dynamic electric supply limitations, and other voluntary limitations. Further, the available current may be refined taking into account the charging priority levels of the vehicles charging at the time of arrival on said charging point. The charge spot 11 may be configured to send load status information periodically or on request in order to refine the load status estimation based on the vehicle flow forecast. This may improve the charging time estimation.

FIG. 4 illustrates steps of a method of estimating charging time at a charge spot of interest and at a time of interest for a given electric vehicle. In a first step S101, a charge spot of interest is selected. Advantageously, the charge spot of interest may be a charge spot determined in the route planning as a potential stop for the electric vehicle. In a second step S102, a time of interest is selected. Advantageously, the time of interest may be an expected time of arrival of the electric vehicle at the charge spot of interest based on the route planning. In a third step S103, a load status of the charge spot is determined at the time of interest based on the forecast of the flow of electric vehicles to the charge spot. A waiting time prior to charging the vehicle may be derived from the load status. Indeed, when all charging lines are busy at the time of interest, the waiting time may be the time until one charging line will become free. The time until one charging line becomes free can be evaluated based on the route planning of the other EV connected to the charge spot. In a fourth step S104, the charge spot controller may retrieve electric supply infrastructural limitations. This may enable to estimate an available current for charging the EV at the charge spot and at said service time. Indeed, it may be important to consider the maximum current that a charging line can supply as well as the maximum current that a charging spot can globally supply since these infrastructural limitations may limit the available current for charging an EV at a charge spot. As explained, the infrastructural limitations may be caused by a maximal current able to be supplied on the cable connecting the charge spot to the power grid and on the cables connecting the electric vehicles to the charge spot (charging lines). In a fifth step S105, electric supply dynamic limitations may be retrieved by the charge spot controller. This may enable to refine the available current estimation. As explained above, electric supply dynamic limitations may be caused by variations of the power grid capacity and may be provided by a company managing the supply of electricity from of the power grid (power grid management company). In a sixth step S106, voluntary limitations such as financial limitations set by the charge spot controller are determined. This may also enable to refine the available current estimation. In a seventh step S107, the service duration is evaluated by refining the available current in view of the above limitations.

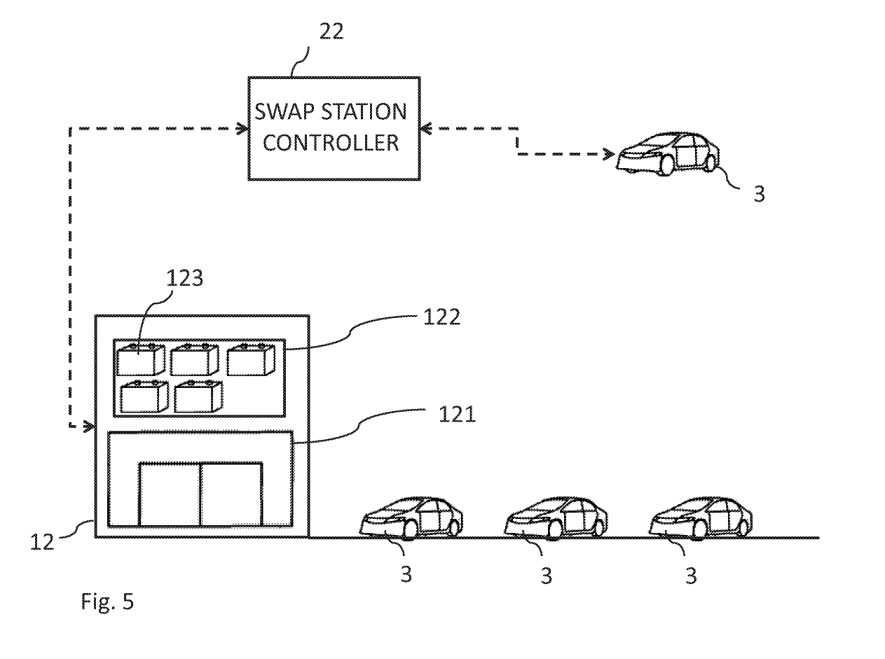

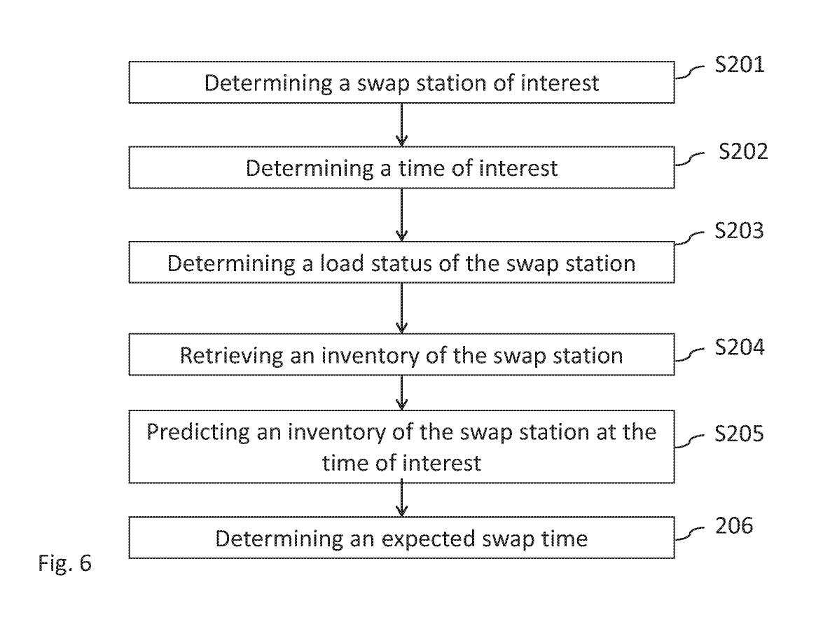

FIG. 5 shows an exemplary case in which the electric vehicle service network comprises a swap station. The swap station 12 is part of the electric vehicle service network presented in FIG. 1 and the swap station controller 22 is part of the control center system presented in FIG. 1. In the sake of conciseness, the general features relative to the electric vehicle, service station and control center system which are common are not repeated hereinbelow and only details relevant to the exemplary case discussed are hereby further added. Particularly, FIG. 5 illustrates a control system collaborating with an electric vehicle 3 and a swap station 12.

The swap station 12 may comprise a battery warehouse 122 in which batteries 123 are charged and stored and one or more battery swap lanes 121 for receiving a vehicle and exchanging a spent (or at least partially spent) battery in an electric vehicle 3 by a charged (or at least partially charged) battery from the battery warehouse 122. The battery warehouse 122 may comprise battery of different types and at different charge status. Indeed, when a battery is extracted from a vehicle 3 and inserted in the battery warehouse, the battery may be charged so as to be able to be later reintroduced into an electric vehicle. The battery warehouse 122 may periodically or on request communicate an inventory of the batteries contained in the warehouse to the swap station controller 22. The inventory may comprise data relative to the batteries in the battery warehouse 122 and their respective charge status. Further, the swap station 12 may be configured to send periodically or on request to the swap station controller 22 information relative to a number of electric vehicles 3 waiting for battery swap at the swap station 12.

The swap station controller 22 may be configured to evaluate the service duration for servicing a given electric vehicle 3 at a given swap station 12 and at a given service time based on the forecast of the flow of electric vehicles to the swap station. The swap station controller 22 may determine a waiting time prior to battery swap by estimating a load status of the swap station 12 i.e. predicting whether a battery swap lane should be free or if a certain amount of vehicles are expected to wait for a battery swap at the given service time. Further, on request or periodically, the swap station controller 22 may be configured to receive an inventory from the swap station 12. Together with the vehicle flow forecast at the swap station, this enables to determine if, at the given service time, a given battery type suitable for the given vehicle is expected to be available. Indeed, the inventory, at the time of request, of the batteries stored in the swap station 12 and the knowledge of the flow of vehicle from the time of request to the service time enables to determine which battery should be left in the swap station at the service time (i.e. time of arrival of the electric vehicle to be serviced). Further, the swap station controller 22 may be configured to store swap performance data associated with structural features of the swap station 12. Indeed, depending on the physical arrangement of the swap station 12, the average swap time may vary between swap stations. Furthermore, the swap station controller 22 may be configured to receive periodically from the swap station 12 data relative to a waiting time prior to battery swap. This may enable to build statistical data of the waiting time and to obtain a distribution of the waiting time observed over a predetermined period such a day, week or month. The statistical data may also be used in evaluating the swap time.

FIG. 6 illustrates steps of a method of estimating swap time at a swap station of interest and at a time of interest for a given electric vehicle. In a first step S201, a swap station of interest is selected. Advantageously, the swap station of interest may be a swap station determined in the route planning as a potential stop for the electric vehicle. In a second step S202, a time of interest is selected. Advantageously, the time of interest may be an expected time of arrival of the electric vehicle at the swap station of interest according to the route planning. In a third step S203, a load status of the swap station of interest is evaluated at the time of interest (service time). The load status may be determined based on the vehicle flow forecast which is established based on the route planning of the fleet of electric vehicle. The load status may comprise a number of free battery exchange lanes or a number of other vehicles to be serviced prior to the given electric vehicle of interest. The number of electric vehicle to be serviced prior to the given vehicle may provide for an estimation of the waiting time prior to battery swap. In a fourth step S204, an inventory of the swap station may be retrieved. A fresh inventory may be communicated on request by the swap station or a earlier inventory previously transmitted and stored on a memory storage may be retrieved. In a fifth step S205, a prospect inventory of the swap station at the time of interest is predicted. The prospect inventory at the time of interest may be based on the inventory retrieved (fresh inventory or earlier inventory) and on the vehicle flow forecast and/or on a vehicle flow history. For example, based on the batteries are in the swap station at a first time of earlier inventory, on the vehicles that have been serviced from said first time and on the vehicles that are expected to be serviced until the time of interest, it is possible to build an estimation of the batteries that are expected to be in the swap station at the time of interest. Additionally, the swap station controller may be configured to predict a charge status of the batteries at the time of interest. In a sixth step S206, an expected swap time is estimated by adding an expected waiting time prior to battery swap and a battery swap standard time (average swap time). The expected waiting time prior to battery swap may be based on the number of electric vehicle expected to be serviced prior to the given vehicle. Additionally, it is possible to refine the waiting time based on the prospect inventory of the given swap station. Indeed, based on the prospect inventory, it is possible to evaluate if a battery suitable for the given electric vehicle is expected to be available at the given swap station and at the given time of interest. If such battery is available, the waiting time prior to battery swap previously estimated is valid. If a battery is not available, then the waiting time prior to battery swap previously estimated is generally substantially increased because of the need to order and deliver a suitable battery to the swap station. Further, a battery suitable for the given vehicle may be available in the swap station but not be sufficiently charged. Therefore, the waiting time may be increased so that the battery charge status reaches a sufficient level. The sufficient level may depend on the route planning of the given electric vehicle and on the proximity of the next service station stop in the EV energy plan.

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

1. A control system for monitoring an electric vehicle service network, the electric vehicle service network comprising a plurality of service stations providing electric energy reload to a fleet of electric vehicles, the control system being configured and operable for communication with the electric vehicles via a communication network, the control system comprising:
a processing unit configured for aggregating vehicle route planning information associated with at least some of the electric vehicles to build forecast data of the flow of electric vehicles to the service stations over time, wherein the route planning information of a vehicle comprises data indicative of one or more stops at one or more service stations over time if a final destination of said electric vehicle is out of range of said vehicle;
a service time estimation unit configured and operable for utilizing the forecast data and evaluating the service duration for servicing a given electric vehicle at a given service station and at a given service time based on said forecast.

2. The control system according to claim 1, further comprising an electric vehicle supervision unit configured for receiving from at least some of the electric vehicles data relative to a battery charge status, a vehicle location and a vehicle final destination of said electric vehicles and wherein the processing unit is configured to process said data to obtain the vehicle route planning information of said electric vehicles.

3. The control system according to claim 1, wherein the electric vehicle supervision unit is configured for receiving from at least some of the electric vehicles data relative to the vehicle route planning of said electric vehicles.

4. The control system according to claim 1, wherein the service time estimation unit is configured for evaluating a load status at the given service station and at the given service time so as to determine a waiting time prior to servicing the electric vehicle.

5. The control system according to claim 1, wherein the given service station is a given charge spot, and the service time estimation unit is configured for estimating a current available for charging the battery of said electric vehicle at said charge spot and at said service time so as to evaluate a charging time for charging the battery.

6. The control system according to claim 5, further comprising a power network supervision unit configured for determining a dynamic current supply limitation at one or more charge spots of the electric vehicle service network and wherein the service time estimation unit is configured for refining the available current estimation based on the dynamic current supply limitation.

7. The control system according to claim 5, further comprising an infrastructure supervision unit configured for storing infrastructural current supply limitation at one or more charge spots of the electric vehicle service network and wherein the service time estimation unit is configured for refining the available current estimation based on the infrastructural current supply limitation at the given charge spot.

8. The control system according to claim 5, further comprising a charge spot supervision unit configured for requesting and receiving data relative to a number of electric vehicle charging on a charge spot at a time of request and wherein the service time estimation unit is configured for refining the expected number of electric vehicle serviced by the given charge spot at a given time based on said received data.

9. The control system according to claim 1, wherein the given service station is a swap station, and the service time estimation unit is configured for evaluating the service duration based on a waiting time prior to the battery swap at the given service time estimated by determining a number of vehicles awaiting for a battery swap at the swap station and at the given service time.

10. The control system according to claim 9, further comprising a swap station supervision unit configured for requesting and receiving to and from the swap stations data relative to a number of electric vehicle awaiting at said swap stations at a time of request and wherein the service time estimation unit is configured for refining the waiting time at the given service time at the given swap station based on the number of vehicle awaiting at said swap station at the time of request.

11. The control system according to claim 10, wherein the swap station supervision unit is further configured for requesting and receiving to and from the swap stations an inventory of the batteries available at said swap stations at a time of request and the service time estimation unit is configured for determining the waiting time at a given swap station at a given service time for a given electric vehicle based on said inventory.

12. The control system according to claim 11, wherein the inventory of the batteries available at a swap station at a time of request comprises data relative to a type of battery and a charge status.

13. The control system according to claim 1, wherein the electric vehicles of the fleet are associated with a level of servicing priority, and the service time estimation unit is configured for refining the service duration for servicing a given vehicle based on the level of servicing priority of said vehicle.

14. The control system according to claim 1, configured to periodically receive use data from the plurality of service stations so as to build a statistical use distribution of the service stations over time and wherein the service time estimation unit is configured for refining the service duration based on said statistical use distribution.

15. The control system according to claim 1, further comprising a service time communication unit configured for transmitting the service time estimation to the electric vehicles.

16. A method comprising:
establishing, by a computer processor, route planning for a plurality of electric vehicles of a electric vehicle fleet based, at least in part, on data relative to a battery charge status, a vehicle location and a vehicle final destination of each electric vehicle of the plurality of electric vehicles, wherein the route planning of an electric vehicle includes one or more service station stops over time when the vehicle final destination is out of range of the vehicle based on the battery charge status and the location of said vehicle;
aggregating, by the computer processor, the route planning from each electric vehicle of the plurality of said at least some electric vehicles of the fleet;
generating, by the computer processor, forecast data for a flow of electric vehicles to at least one service station of an electric vehicle service network over time; and
evaluating, by the computer processor, based on the forecast data, a service duration for servicing a given electric vehicle at the at least one service station during a given service time.

17. (canceled)

18. (canceled)
